(19) United States
(12) Patent Application Publication
(10) Pub. No.: US 2013/0152975 A1
(43) Pub. Date: Jun. 20, 2013

(54) MULTI-ENGINE WASH HARNESS SYSTEMS AND METHODS

(71) Applicants: Travis Heywood, South Jordan, UT (US); James McCormick, Sandy, UT (US)

(72) Inventors: Travis Heywood, South Jordan, UT (US); James McCormick, Sandy, UT (US)

(21) Appl. No.: 13/326,001

(22) Filed: Dec. 14, 2011

(51) Int. Cl. B08B 3/02; B08B 5/00; B08B 3/08

(52) U.S. Cl. 134/26; 134/103.2; 134/98.1; 134/25.5

(57) ABSTRACT

A turbine engine cleaning system includes a source of cleaning fluid, a source of rinse fluid, a pump configured to deliver the cleaning fluid and rinse fluid under pressure, and a wash harness. The wash harness is connected in flow communication with a plurality of turbine engines. The wash harness is configured to direct cleaning fluid from the source of cleaning fluid and rinse fluid from the source of rinse fluid from the pump to the turbine engines in sequence.

### TECHNICAL FIELD

The present disclosure relates generally to engine cleaning systems, and more particularly relates to aircraft engine cleaning systems that concurrently clean multiple engines.

### BACKGROUND

Jet engines and turbine engines typically include turbine blades that are specially designed to maintain cooler temperatures in the blades. The turbine blades typically include channels formed therein through which fresh air is driven to cool the turbine blades. The fresh air flows through outlet holes on the turbine blades out into the hot gas flow surrounding the turbine blades. The relatively cool fresh air helps counterbalance the super high exhaust temperatures that the turbine blades are exposed to thereby protecting the blades from melting. As the engines operate, deposits begin to accumulate on the tips of the turbine blades in the area of the outlet holes of the fresh air channels. The deposits can sometimes occlude the air outlet holes, which results in hot spots forming on the tips of the turbine blades. Sometimes these hot spots develop into melted material and may even result in chunks of the blade dislodging, thus throwing the turbine out of balance. Further, as the deposits build up on the turbine blades, the aerodynamics of the turbine blades are modified, thus reducing the efficiency of the engine. As the efficiency goes down, the engine begins running hotter at a specific power output level.

The process of cleaning jet and turbine engines to remove these undesirable deposits is well known. Typically, a soap or detergent (also referred to as a gas path cleaner) is passed through the engine followed by a water rinse. An example cleaning system includes a pumping system that is connected to the engine with a plurality of hoses that draw cleaning and rinse fluids from tanks of various sizes. The process of setting up the cleaning system, including bringing all of this equipment into proximity to the engine, confirming proper set-up of the cleaning system and engine, operating the engine and cleaning system during the cleaning cycle, disconnecting the cleaning system, and resetting the engine is very time consuming. Opportunities exist for improvements in engine cleaning systems and methods.

### SUMMARY

One aspect of the present disclosure relates to a turbine engine cleaning system that includes a source of cleaning fluid, a source of rinse fluid, a pump configured to deliver the cleaning fluid and rinse fluid under pressure, and a wash harness. The wash harness is connected in flow communication with a plurality of turbine engines. The wash harness is configured to direct cleaning fluid from the source of cleaning fluid and rinse fluid from the source of rinse fluid to the plurality of turbine engines in sequence.

The wash harness may include a valve system that is operable to control the flow of cleaning fluid and rinse fluid from the wash harness to the plurality of turbine engines. The turbine engine cleaning system may include a first hose assembly connecting the wash harness to a first of the plurality of turbine engines, a second hose assembly connecting the wash harness to a second of the plurality of turbine engines, and a third hose assembly connecting the wash harness in flow communication with the pump. Each of the first, second and third hose assemblies may include at least one hose. The pump, source of cleaning fluid, and source of rinse fluid may be carried on a mobile cart, and the wash harness is portable relative to the mobile cart.

The turbine engine cleaning system may include a compressor configured to provide compressed air to the plurality of turbine engines. The cleaning fluid and rinse fluid may be directed to only one of the plurality of turbine engines at a time. One of the cleaning fluid and the rinse fluid may dwell in one of the plurality of turbine engines while one of the cleaning fluid and the rinse fluid is directed to another of the plurality of turbine engines. The cleaning fluid may comprise a detergent. The wash harness may be connected in flow communication with at least one of a compressor portion and a combustion portion of each of the plurality of turbine engines.

Another aspect of the present disclosure relates to a turbine engine cleaning system that includes first and second hose assemblies, a pump system and a wash harness. The first hose assembly is connected in flow communication with a first turbine engine. The second hose assembly is connected in flow communication with a second turbine engine. The wash harness is connected in flow communication with the first and second hose assemblies and the pump system. The wash harness is operable to control flow of cleaning fluid and rinse fluid from the pump system to the first and second hose assemblies to clean the first and second turbine engines simultaneously.

The turbine engine cleaning system may include a first tank holding the cleaning fluid, a second tank holding the rinse fluid, and a mobile cart configured to carry the pump system and the first and second tanks. The first and second hose assemblies may each include a liquid hose connected to a cleaning inlet of the first and second turbine engines, and an air hose connected to an air inlet of the first and second turbine engines. The pump system may include a plurality of valves configured to control the flow of cleaning fluid and rinse fluid to and from the wash harness. The first hose assembly may be connected in flow communication with at least one of a compressor portion and a combustion portion of the first turbine engine, and the second hose assembly may be connected in flow communication with at least one of a compressor portion and a combustion portion of the second turbine engine.

A further aspect of the present disclosure relates to a method of concurrently cleaning a plurality of turbine engines. The method includes providing a cleaning fluid, a rinse fluid, a pump, and a wash harness, connecting the wash harness in flow communication with the pump and the plurality of turbine engines, delivering the cleaning fluid and rinse fluid under pressure to the wash harness with the pump, and directing the cleaning fluid and rinse fluid to a first of the plurality of turbine engines and a second of the plurality of turbine engines with the wash harness to clean the first and second turbine engines.

The method may include spooling the first turbine engine before directing the cleaning fluid and rinse fluid to the first turbine engine, and spooling the second turbine engine before directing the cleaning fluid and rinse fluid to the second turbine engine. Directing the cleaning fluid and the rinse fluid may include delivering the cleaning fluid first followed by delivering the rinse fluid. Directing the cleaning fluid and the rinse fluid may include delivering the cleaning fluid to the first turbine engine, followed by delivering cleaning fluid to the second turbine engine, followed by delivering rinse fluid to the first turbine engine, followed by delivering rinse fluid to the second turbine engine.

Connecting the wash harness in flow communication with the first and second turbine engines may include connecting to at least one of an engine compressor and a combustion portion of the first and second turbine engines. The method may include permitting a dwell time to elapse between directing the cleaning fluid to the first and second turbine engines and directing the rinse fluid to the first and second turbine engines.

The foregoing and other features, utilities, and advantages of the invention will be apparent from the following detailed description of the invention with reference to the accompanying drawings.

### BRIEF DESCRIPTION OF THE DRAWINGS

The accompanying drawings illustrate various embodiments of the present disclosure and are a part of the specification. The illustrated embodiments are merely examples of the present disclosure and do not limit the scope of the invention.

FIG. 1 is a perspective view of an example engine cleaning assembly connected to a pair of aircraft engines in accordance with the present disclosure.

FIG. 2 is a perspective view of an example wash harness of the engine cleaning assembly of FIG. 1.

FIG. 3 is a rear view of the wash harness of FIG. 2.

FIG. 4 is a rear view of the wash harness of FIG. 3 with a plurality of hose assemblies connected thereto.

FIG. 5 is a perspective view of an engine wash system of the engine cleaning assembly of FIG. 1.

FIG. 6 is another perspective view of the engine wash system of FIG. 5.

FIG. 7 is a close-up view of a first engine of the aircraft of FIG. 1 connected to the wash harness.

FIG. 8 is a close-up view of a second engine of the aircraft of FIG. 1 connected to the wash harness.

FIG. 9 is a perspective view of another example engine cleaning assembly connected to a pair of aircraft engines in accordance with the present disclosure.

FIG. 10 is a perspective view of an engine wash system of the engine cleaning assembly of FIG. 9.

FIG. 11 is a block diagram showing an example engine cleaning assembly in accordance with the present disclosure.

FIG. 12 is a block diagram showing another example engine cleaning assembly in accordance with the present disclosure.

FIG. 13 is a block diagram showing another example engine cleaning assembly in accordance with the present disclosure.

FIGS. 14-19 are flow diagrams showing example methods in accordance with the present disclosure.

Throughout the drawings, identical reference numbers designate similar, but not necessarily identical, elements.

### DETAILED DESCRIPTION

The present disclosure is directed to systems and methods for cleaning engines. One example embodiment is directed to an engine cleaning assembly that may be connected to multiple engines at the same time. The engine cleaning assembly may be used to perform a cleaning cycle for each of the engines. At least some portions of the cleaning cycle (e.g., cleaning, rinsing and cooling the starter engine) for the engines may occur concurrently. For example, the engine cleaning assembly may first deliver a cleaning fluid (e.g., a gas path cleaner) to a first engine. The engine cleaning assembly delivers a volume of the cleaning fluid to the second engine while the cleaning fluid is dwelling in the first engine. The engine cleaning assembly flushes the cleaning fluid from the first engine using a rinse fluid while the cleaning fluid is dwelling in the second engine. The cleaning fluid is flushed from the second engine with a rinse fluid while the rinse fluid is dwelling in the first engine. The rinse fluid is flushed from the first engine while the rinse fluid is dwelling in the second engine. The rinse fluid is then flushed from the second engine.

In other arrangements, both the first and second engines may be cleaned with cleaning fluid concurrently followed by rinsing both of the first and second engines either in series or concurrently. In some arrangements, no dwell period is needed for the rinse fluids in the engines. Many variations on the sequence of delivering fluids to the plurality of engines using an engine cleaning assembly are possible.

The present disclosure is also directed to use of a portable wash harness as part of an engine cleaning assembly. An engine wash system of the engine cleaning assembly may deliver various fluids (e.g., cleaning fluid, rinse fluid and pressurized air) to the wash harness, and the wash harness controls fluid flow to a plurality of engines that are connected in flow communication with the wash harness. The wash harness may include controls for controlling the fluid flow to each of the engines. The wash harness may include, for example, a harness or strap that facilitates carrying of the wash harness by a user and repositioning the wash harness relative to the engines being cleaned and the engine wash system.

In some arrangements, the engine cleaning assembly includes one engine wash system and a plurality of wash harnesses that are each coupled in flow communication with the wash system and a plurality of engines. In other arrangements, the flow control features of the wash harness are incorporated into the engine wash system. The engine wash system itself may be portable so as to be repositionable relative to the plurality of engines. In other embodiments, the engine wash system is stationary (e.g., a fixed mounting in a building such as a hanger where the aircraft is housed) and the mobile wash harness is mobile for easier access to the engines.

The ability to perform at least portions of the cleaning cycle for multiple engines concurrently using one engine cleaning assembly provides significant time savings compared to existing cleaning systems that connect to and clean one engine at a time. Further, in at least some scenarios, providing a portable wash harness with controls for controlling fluid flow to each of the plurality of engines may make it possible to reduce the number of personnel required to perform a cleaning cycle. The engine cleaning assembly disclosed herein may also provide improved efficiency in utilizing the features of the engine cleaning assembly within a given time period by eliminating some of the downtime that typically occurs while cleaning and rinse fluids dwell in the engine and the engine starter motors are allowed to cool between spooling.

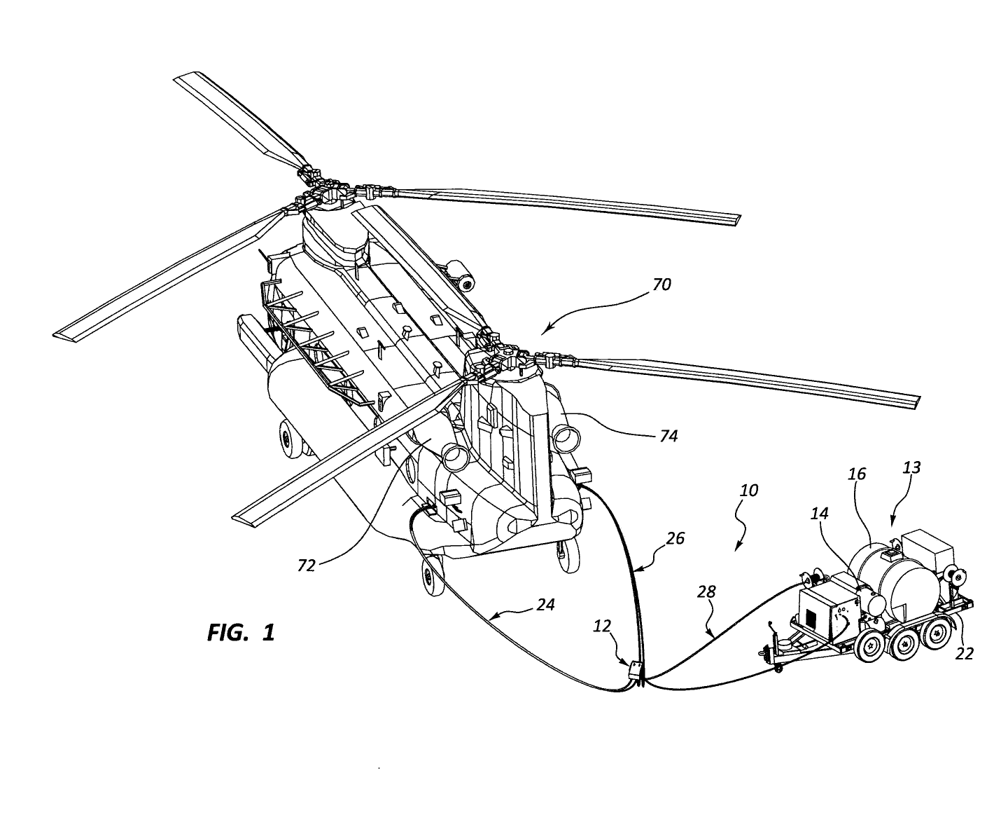

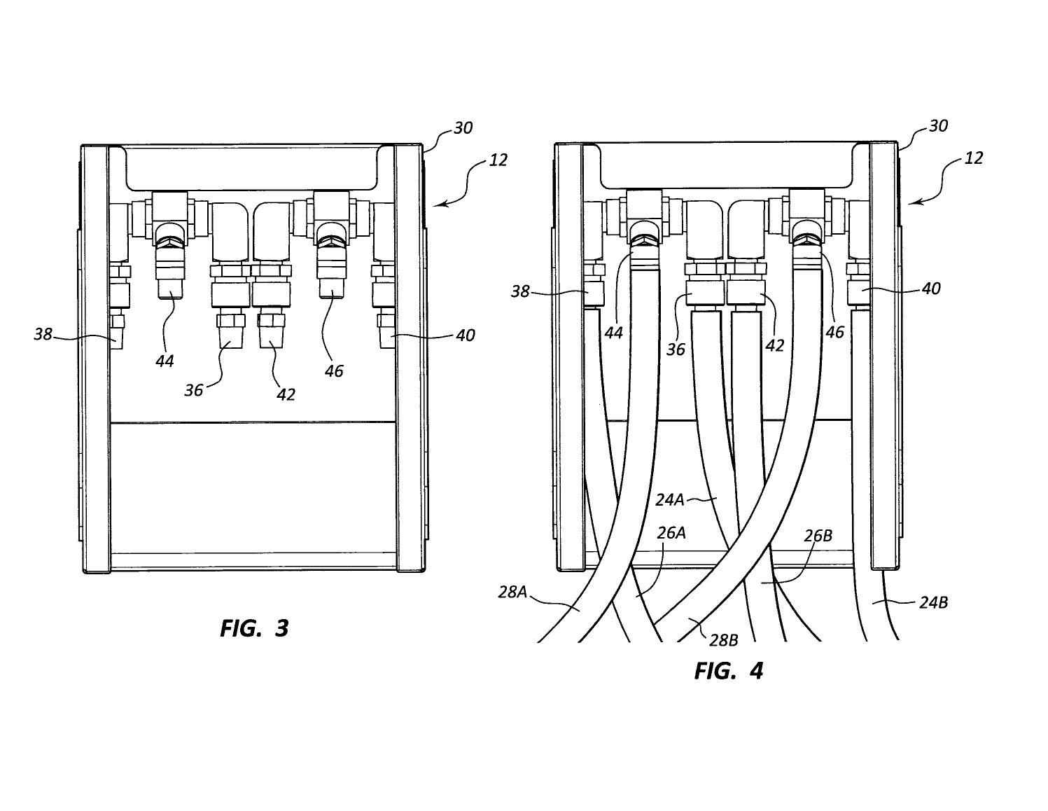

Referring now to FIGS. 1-8, an example engine cleaning assembly 10 is shown in use connected to first and second engines 72, 74 of an aircraft 70. The engine cleaning assembly 10 includes a wash harness 12 and an engine wash system 13. The wash harness 12 is coupled to the first and second engines 72, 74 with first and second hose assemblies 24, 26. The wash harness 12 is coupled to the engine wash system 13 with a third hose assembly 28. The first, second and third hose assemblies 24, 26, 28 may each include first and second hoses 24A,B, 26A,B, 28A,B, respectively. In other arrangements, different numbers of hoses may be included in each of the first, second and third hose assemblies 24, 26, 28.

The engine wash system 13 may include a cleaning fluid source 14, a rinse fluid source 16, controls 18, a pump 19, a compressor 20, and a cart 22. The components of engine wash system 13 may be carried on cart 22, which provides mobility for the engine wash system 13. The engine wash system 13 may include other fluid sources such as, for example, a reservoir of compressed air generated by compressor 20. The engine wash system 13 may also include a plurality of reels to collect the first, second and third hose assemblies 24, 26, 28.

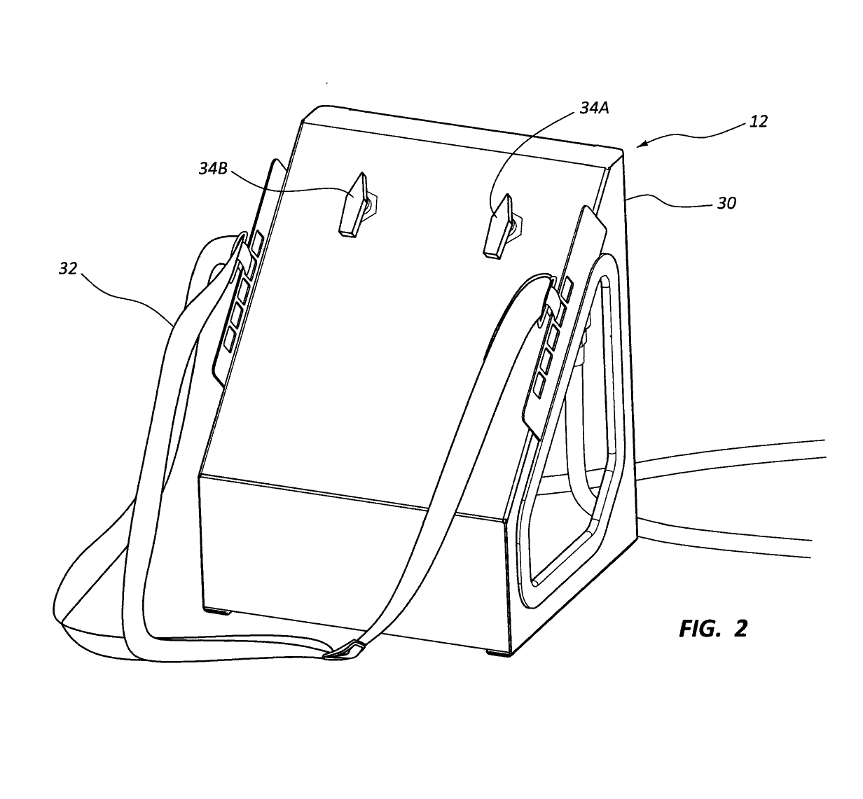

Referring now to FIGS. 2-4, the wash harness 12 includes a housing 30, a carrying strap 32, flow actuators 34A,B, first and second cleaning outlet connectors 36, 38, first and second air output connectors 40, 42, a cleaning input connector 44, and an air input connector 46. The carrying strap 32 may be used to lift and carry the wash harness 12. The carrying strap 32 may be configured as a shoulder strap for a single user to lift and carry the wash harness 12. In some embodiments, the carrying strap 32 may be configured as a gripping handle. In other arrangements, multiple straps, handles or other handling features may be included for purposes of lifting and carrying the wash harness 12.

Typically, the first and second cleaning output connectors 36, 38 and the first and second air output connectors 40, 42 are connected to hoses 24A,B and 26A,B of the first and second hose assemblies 24, 26, as shown in FIG. 4. The cleaning and air input connectors 44, 46 are connected to hoses 28A,B of the third hose assembly 28, as shown in FIG. 4. Cleaning and rinse fluids are delivered through hose 28A of the third hose assembly 28 to the cleaning input connector 44 where the cleaning and rinse fluids are directed to the hoses 24A, 26A of the first and second hose assemblies 24, 26 by the flow actuator 34A. Compressed air is delivered through hose 28B of the third hose assembly 28 to the air input connector 46 where the compressed air is directed to the second hoses 24B, 26B of the first and second hose assemblies 24, 26 by the flow actuator 34B.

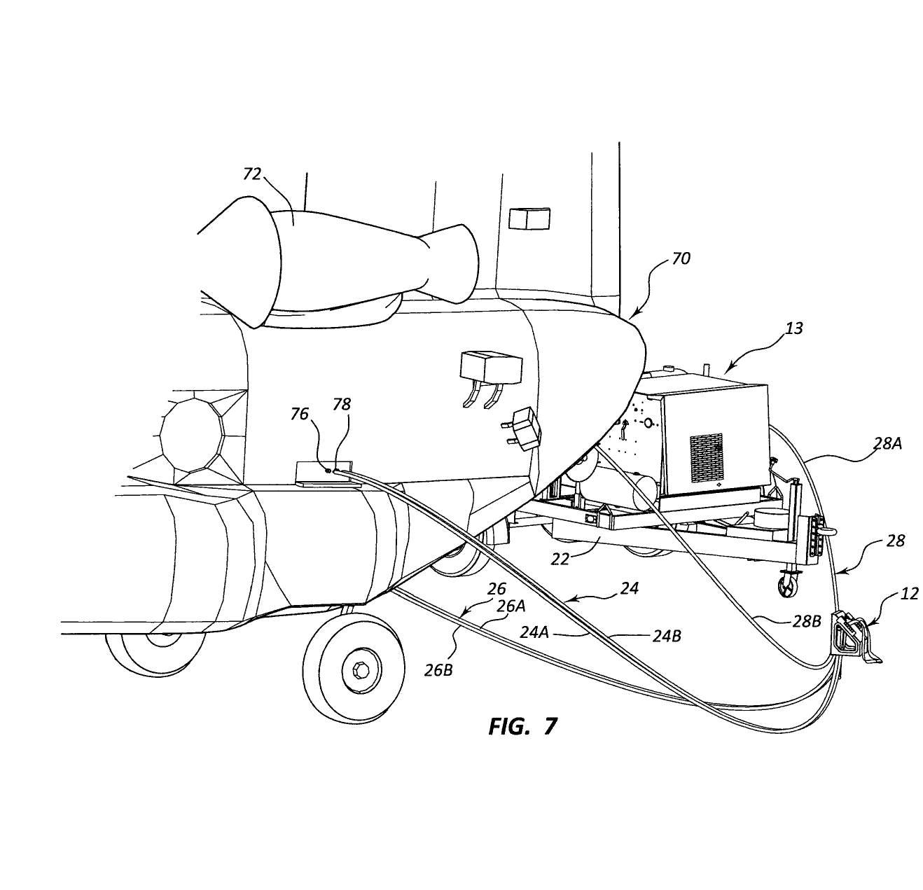

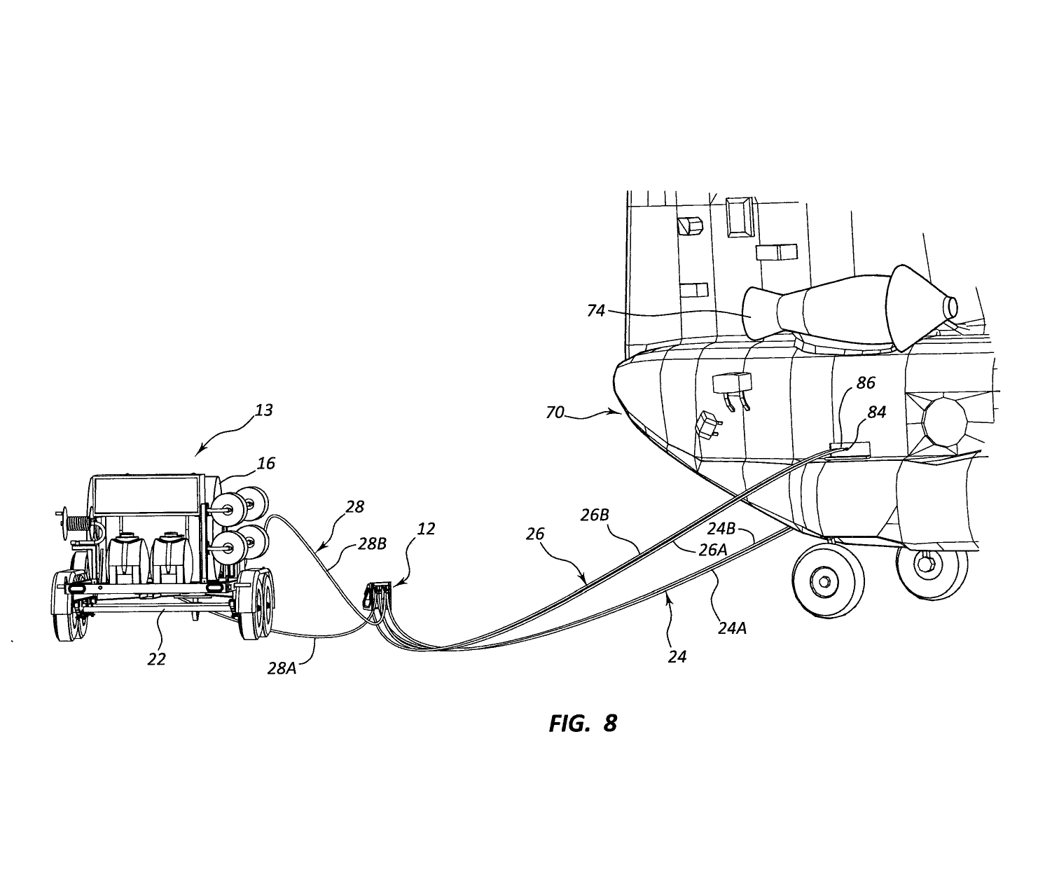

FIG. 7 shows the hoses 24A, 24B of the first hose assembly 24 connected to cleaning inlet 76 and air inlet 78, respectively, of the first engine 72. FIG. 8 shows the hoses 26A, 26B of the second hose assembly 26 connected to cleaning inlet 84 and air inlet 86, respectively, of the second engine 74. The flow actuators 34A, 34B of the wash harness 12 control flow of the cleaning and rinse fluids and compressed air to the first and second hose assemblies 24, 26 to provide cleaning and rinse fluids and compressed air to the first and second engine 72, 74.

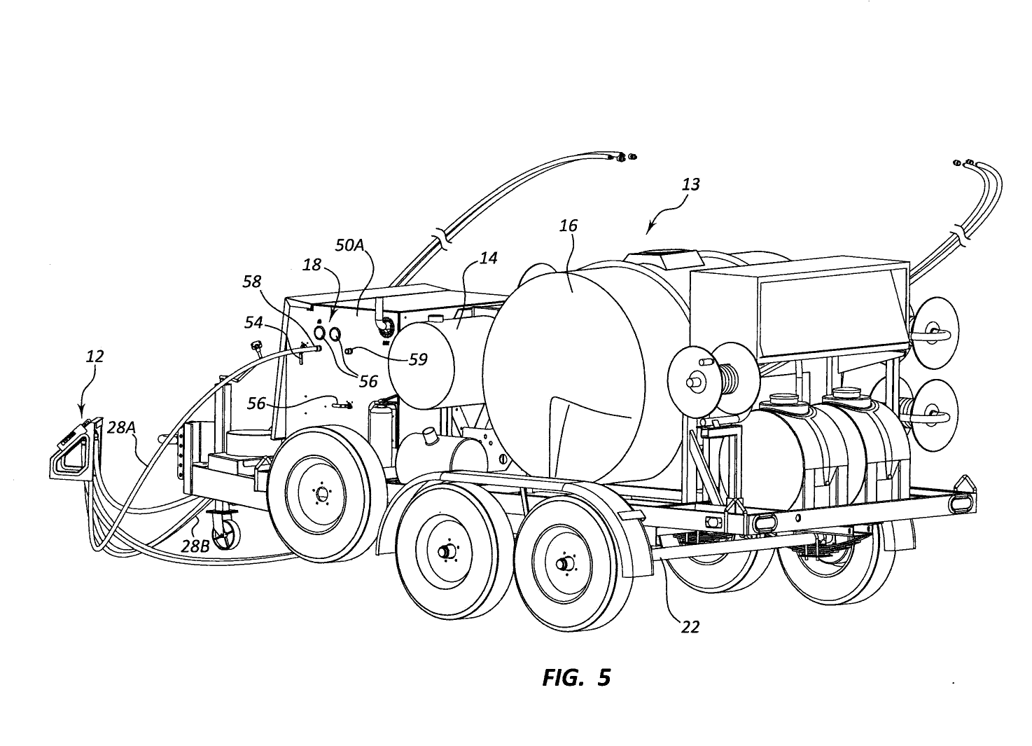

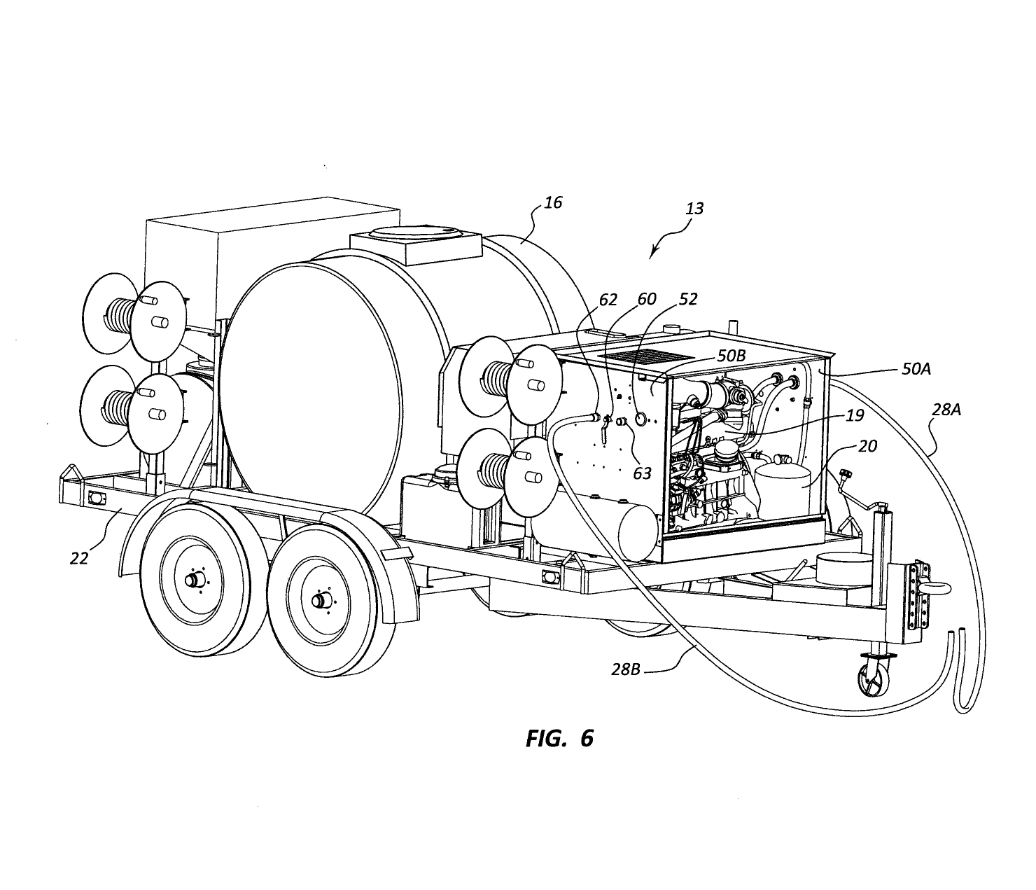

Referring now to FIGS. 5 and 6, the controls 18 are shown and described in further detail. Controls 18 may include a first control panel 50A having a plurality of gauges 52, a cleaning on/off valve 54, a source valve 56, and a cleaning outlet connector 58. The gauges may show status of, for example, fluid pressures and fluid volumes of the engine wash system 13. The cleaning on/off valve 54 may control flow through cleaning outlet connector 58 to first hose 28A of the third hose assembly 28. Source valve 56 may operate to control which of the cleaning and rinse fluids is delivered from the cleaning fluid source 14 and rinse fluid source 16 to the first hose 28A at the cleaning outlet connector 58. The first control panel 50A may include a second cleaning connector 59 for connection of an additional hose assembly, for example, for use with an additional wash harness.

Second control panel 50B shown in FIG. 6 includes an air on/off valve 60 and an air outlet connector 62. Second control panel 50B may also include at least one gauge 52 that shows a status of the compressed air such as an air pressure available at the air outlet connector 62. The air on/off valve 60 may control flow of compressed air to second hose 28B of the third hose assembly 28. The second control panel 50B may include a second air outlet connector 63 for connection of an additional hose assembly for use with, for example, an additional wash harness.

The pump 19 and compressor 20 may be positioned internally within engine wash system 13 as shown in FIG. 6. Pump 19 may control delivery of the cleaning and rinse fluids. The compressor 20 may control generation and storage of compressed air. Typically, the compressed air is delivered at the air outlet connector 62 at a pressure in the range of about 25 psi to about 100 psi, and more preferably in the range of about 50 psi to about 60 psi.

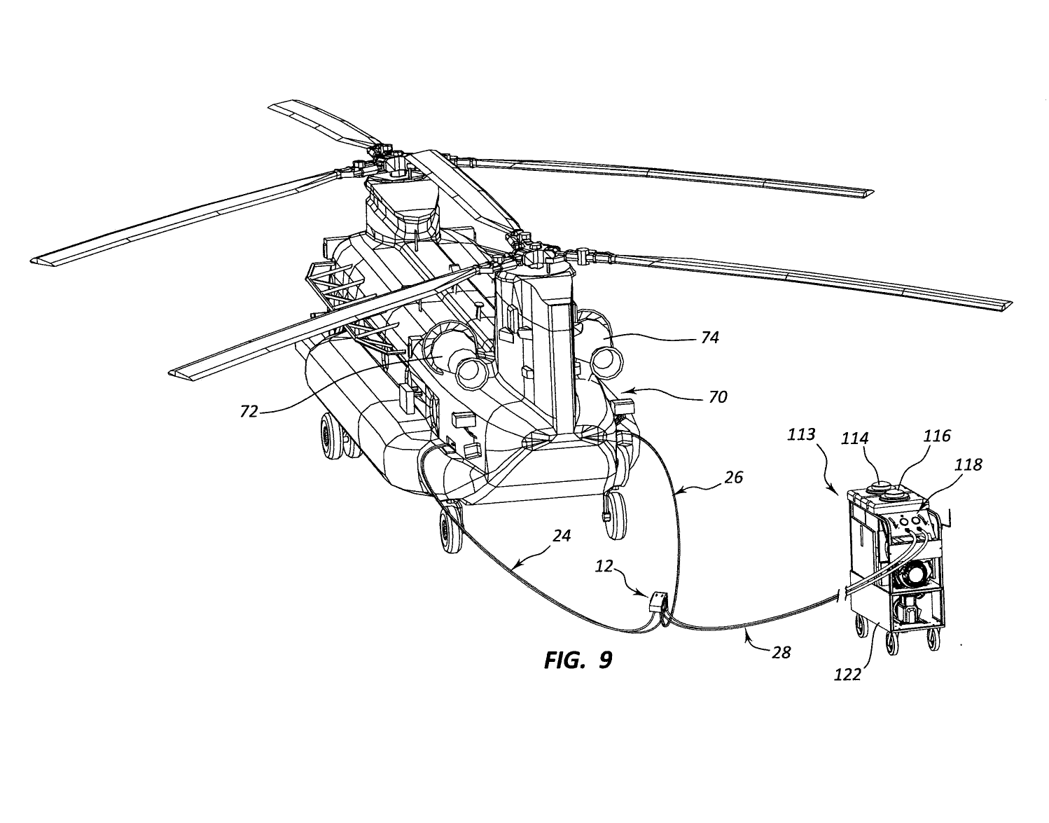

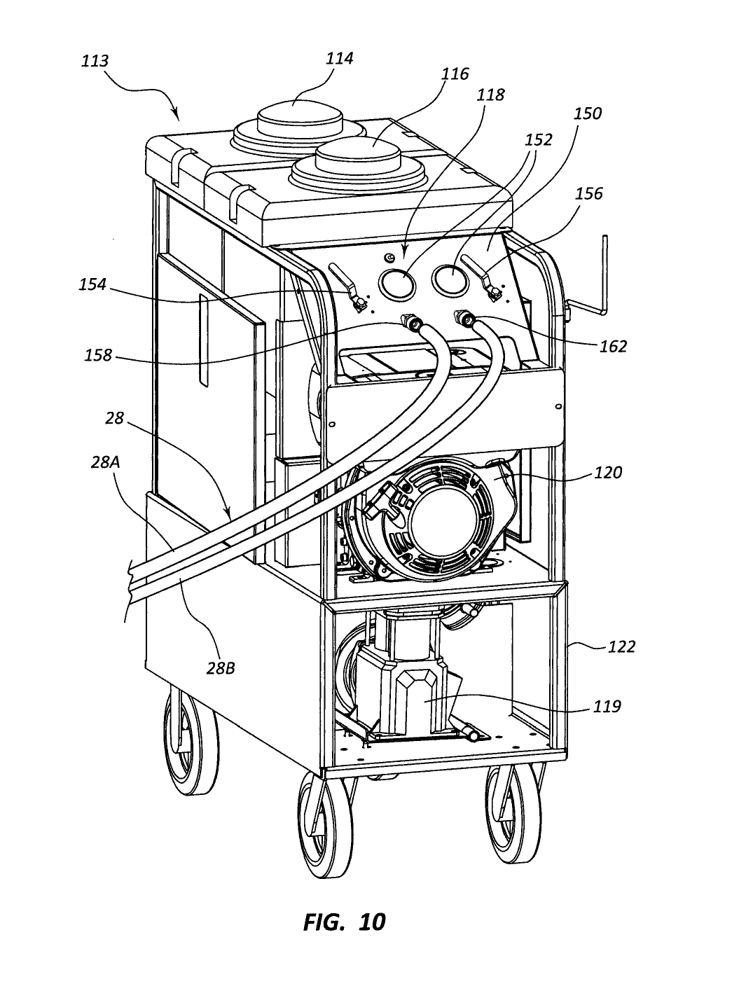

FIGS. 9 and 10 show an alternative engine wash system 113 connected to wash harness 12 and the first and second engine 72, 74 of aircraft 70. Engine wash system 113 includes a cleaning fluid source 114, a rinse fluid source 116, a control 118, a pump 119, a compressor 120, and a cart 122. The cart 122 and other features of engine wash system 113 may be relatively small as compared to the features of engine wash system 13 described above. The engine wash system 113 may be easier to transport and may be movable by hand (e.g., the power of one or two people) rather than requiring movement with a vehicle.

The controls 118 may include a control panel 150 that includes gauges 152, a cleaning on/off valve 154, a source valve 156, a cleaning outlet connector 158, and an air outlet connector 162. The cleaning on/off valve 154 may control flow of cleaning or rinse fluids to the cleaning outlet connector 158 and a first hose 28A of the third hose assembly 28. The source valve 156 may control which of the cleaning and rinse fluids from the cleaning fluid source 14 and rinse fluid source 16, respectively, is delivered to the cleaning outlet connector 158. The second hose 28B may be connected to the air outlet connector 162 for flow communication with a source of compressed air provided by the compressor 120.

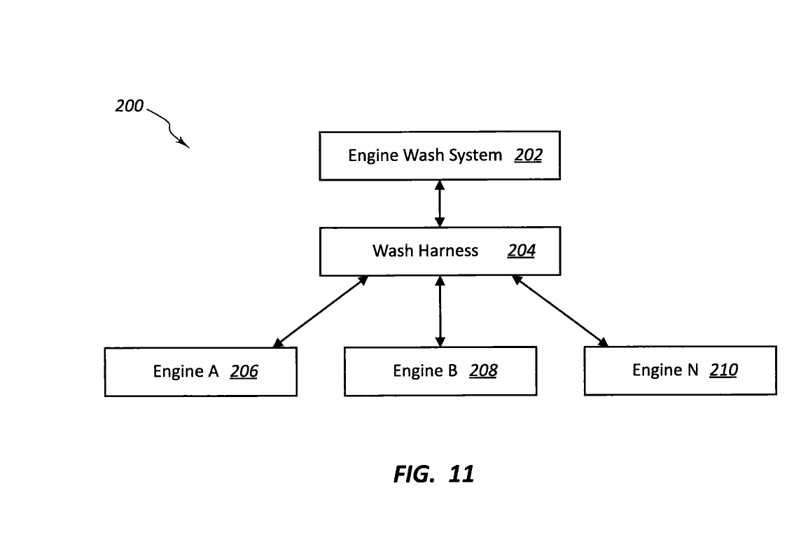

Referring now to FIGS. 11-13, several example engine cleaning assembly configurations are described. FIG. 11 shows an engine cleaning assembly 200 that includes an engine wash system 202, a wash harness 204, and a plurality of engines 206, 208, 210. The plurality of engines may be representative of any number of engines including, for example, the two engines of a single aircraft shown with reference to FIGS. 1-10 described above, three or more engines of a single aircraft, or one or more engines of multiple aircrafts.

The wash harness 204 may be configured to control the flow of cleaning and rinse fluids delivered from the engine wash system 202 to each of the engines 206, 208, 210. The wash harness 204 may also be configured to control the flow of compressed air provided by the engine wash system 202 to any one of the engines 206, 208, 210. The wash harness 204 may be portable relative to the engine wash system 202 and the engines 206, 208, 210.

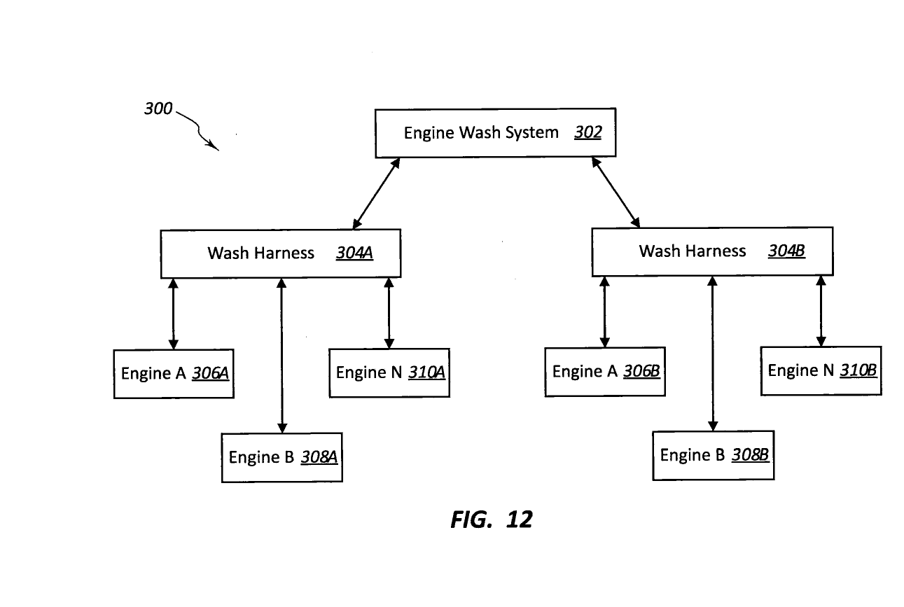

FIG. 12 shows an engine cleaning assembly 300 that includes an engine wash system 302 connected to wash harnesses 304A, 304B. The wash harness 304A is connected to a plurality of engines 306A, 308A, 310A. Wash harness 304B is connected to a plurality of engines 306B, 308B, 310B.

The wash harnesses 304A, 304B represent any number of wash harnesses (e.g., two or more) that may be connected to engine wash system 302. Each of the wash harnesses 304A, 304B may be connected to any desired number of engines such as at least one engine of a single aircraft or at least one engine of each of a plurality of aircraft.

The engine wash system 302 may include separate controls for controlling the flow of cleaning and rinse fluids and compressed air to each of the wash harnesses 304A, 304B. In some configurations, a single valve or controller controls the flow of cleaning and rinse fluids and compressed air to all of the wash harnesses connected to the engine wash system 302.

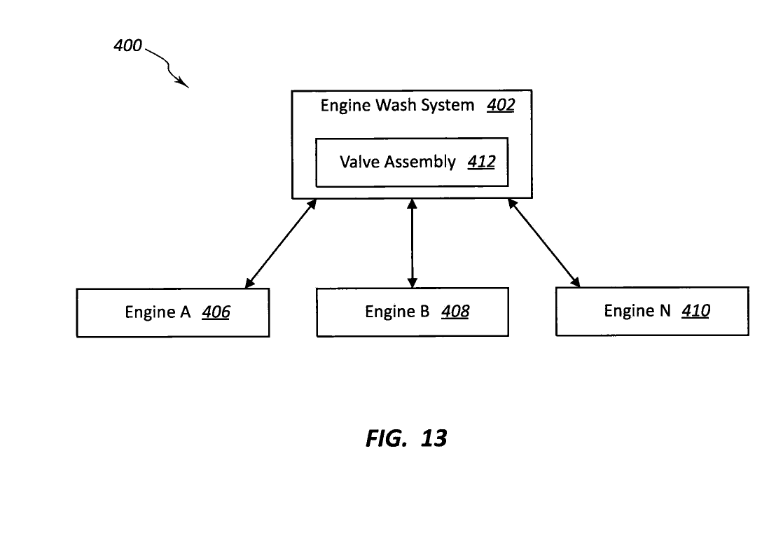

Referring to FIG. 13, another example engine cleaning assembly 400 includes an engine wash system 402 having integrated therein a valve assembly 412 having at least some of the control features of the wash harnesses described herein. For example, the valve assembly 412 may control the flow of cleaning and rinse fluids and compressed air to any one of engines 406, 408, 410. The valve assembly 412 may be integrated into the engine wash system 402, for example, at a control panel of the engine wash system 402. The engine wash system 402 may be mobile using a cart or trailer that provides at least some of the mobility of the wash harnesses described herein.

The wash harnesses and engine wash systems of FIGS. 11-13 may include any of the features and functionality of a wash harness 12 and engine wash systems 13, 113 described with reference to FIGS. 1-10.

An example application of the engine cleaning assemblies described herein involves cleaning a pair of turbine engines of a helicopter (e.g., the aircraft 70). When the helicopter turbine engines are cleaned, a crew of personnel is typically required for the operation. This crew includes a pilot, crew chief and, in some scenarios, a fire guard. These three people coordinate the wash operations via an aircraft intercom system (ICS). First and second hose assemblies are connected to either the compressor manifold of the engines to perform a compression section cleaning, or to nozzles that are connected to ports where the engine igniters have been removed to perform a hot section cleaning. Alternatively, both the hot section and compressor sections may be connected to and cleaned simultaneously.

The pilot spools the first engine with the engine starter and notifies the crew chief over the ICS when the required engine RPM is achieved. The crew chief then operates the wash harness to introduce gas path cleaner to the first engine for a specified period of time (e.g., about 1 min. to about 3 min.). The gas path cleaner typically requires a dwell period in the range of about 5 min. to about 30 min., and more preferably in the range of about 10 min. to about 15 min. to allow the chemicals to act upon the deposits on the turbine blades. The pilot spools down the engine during the dwell period.

The pilot then spools the second engine and notifies the crew chief over the ICS when the required engine RPM is achieved. The crew chief then operates the wash harness to introduce gas path cleaner into the second engine for the specified period of time. The pilot then spools down the second engine while the gas path cleaner dwells in the second engine.

Once the dwell period for the first engine has expired, the pilot spools the first engine and notifies the crew chief over the ICS when the required RPM is achieved. The crew chief then operates the wash harness to introduce rinse fluid into the first engine for the specified period of time. The first engine is then spooled down and, once the dwell time for the second engine expires, the pilot spools the second engine. The pilot notifies the crew chief over the ICS when the required engine RPM is achieved for the second engine and the crew chief operates the wash harness to introduce the rinse fluid into the second engine for the specified period of time. The second engine is then spooled down.

Another rinse cycle may be performed for each of the first and second engines by spooling the engine and introducing an additional flow of rinse fluid for a specified period of time followed by spooling down the engine and waiting for completion of a dwell period.

This process (i.e., a cleaning cycle) of introducing gas path cleaner followed by at least one rinse cycle may be repeated for each engine. Any desired number of rinse cycles may be performed for each cycle of introducing the gas path cleaner. The cleaning cycle may be performed separately or concurrently for the compressor section and hot section of each of the engines.

In addition to the dwell period for the gas path cleaner, the rinse fluid may also require a dwell period. An example dwell period for the rinse fluid may be in the range of about 2 min. to about 10 min., and more preferably about 2 min. to about 5 min. In addition to the dwell periods for the gas path cleaner and rinse fluids, the engine starter motor may also be required to cool down each time the engine is spooled. A starter duty cycle may vary with different aircraft. A typical duty cycle may include:
a first spool cycle of 2 min. on and 2 min. off
a second spool cycle of 2 min. on and 15 min. off
a third spool cycle of 2 min. on and 30 min. off

The cool down periods may extend the amount of time required to perform the cleaning cycle. Providing two or more engines connected to the wash harness of the engine cleaning assembly may permit ongoing operation of the engine cleaning assembly during dwell times of the gas path cleaner and rinse fluid as well as cooling periods for the starter motor.

Returning again to the helicopter cleaning example, the helicopter is typically returned to service and operated under power immediately after the cleaning operation is completed in order to dry the first and second engines. A health indicator test (HIT) is also typically performed to verify that full power has been restored to the engines or if further cleaning is required or recommended.

In some applications such as the helicopter cleaning described above, the mobile wash harness allows the crew chief to be stationed away from the engine wash system. Since the wash manifold is portable, the crew chief may also be mobile and thereby assume the responsibility of the fire guard who typically roams the aircraft and engine cleaning assembly. In this example, the use of the mobile wash harness may eliminate one person from the engine wash process.

Another advantage related to the use of the engine cleaning assembly and the compressed air provided by the engine wash system relates to the operation of air controlled features of the engine. For example, jet engines may have a number of air connections to the engine electronics. Each of these air connections are typically detached from the engine and sealed in order to protect the electronics from fluid intrusion during the cleaning process. Once the air connections and engine ports have been sealed, the seals are required to be inspected before the cleaning cycle is started. The process of cleaning multiple engines of an aircraft is more efficiently completed by making all of the connections to all the aircraft engines at the same time so that one inspection can be completed, as opposed to connecting the wash system to a single engine that requires inspection followed by connection to the other engine at a later time that requires a separate inspection.

Further, many aircraft engines include engine air bands that must be closed during the wash operation to maintain the wash fluids inside the engine. The compressed air provided by the engine cleaning assembly may be connected to multiple air band actuators of the engines. Supplying compressed air operates the air band actuators to maintain closure of the air bands to help maintain the wash fluids inside the engine during the cleaning cycle. Typically, the compressed air is provided by the engine cleaning assembly to the engines prior to and sometimes during delivery of the cleaning and rinse fluids to the engines. In one example, the crew chief operates the wash harness to deliver the compressed air to one or both of the first or second engines of aircraft 70 prior to or after the pilot spools an engine and before delivery of the cleaning fluid or rinse fluid by operation of the wash harness.

The engine cleaning assembly may be configured to flush the cleaning fluid through the first, second and third hose assemblies as part of completing a cleaning cycle for the engines. A single hose may be used for delivering both cleaning and rinse fluids. Typically, the cleaning fluid is first delivered through the hose followed by delivery of the rinse fluid as part of the engine cleaning cycle. The delivery of the rinse fluid flushes the cleaning fluid from the hose and wash harness.

The cleaning and rinse fluids typically are not reclaimed back to the engine wash system, but are rather flushed out of the engines onto the ground or into a fluid reclamation system positioned and arranged to capture the cleaning and rinse fluids as they leave the engine. Some engine cleaning assemblies may include a closed loop cleaning system that reclaims the cleaning and rinse fluids back from the engine to the engine wash system.

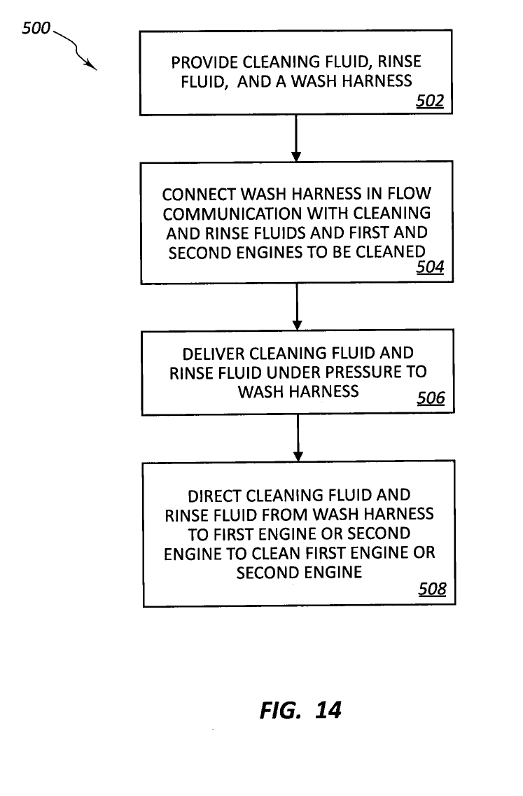

Referring now to FIGS. 14-19, several example methods associated with the example engine cleaning assemblies described herein are shown in flow diagram form. FIG. 14 shows a method 500 that includes a step 502 of providing cleaning fluid, rinse fluid and a wash harness. A step 504 includes connecting the wash harness in flow communication with the cleaning and rinse fluids and first and second engines to be cleaned. Cleaning fluid and rinse fluid are delivered under pressure to the wash harness in step 506. The cleaning fluid and rinse fluid are directed from the wash harness to the first or second engine to clean the first or second engine in a step 508.

Additional steps of method 500 may include delivering the cleaning or rinse fluids concurrently from the wash harness to the first and second engines. The method 500 may include providing dwell times for at least one of the cleaning fluid and rinse fluid in each of the first and second engines. The method 500 may include spooling the first and second engines and waiting to complete cool off periods after spooling down the engines before spooling the engines again between delivery of the cleaning and rinse fluids.

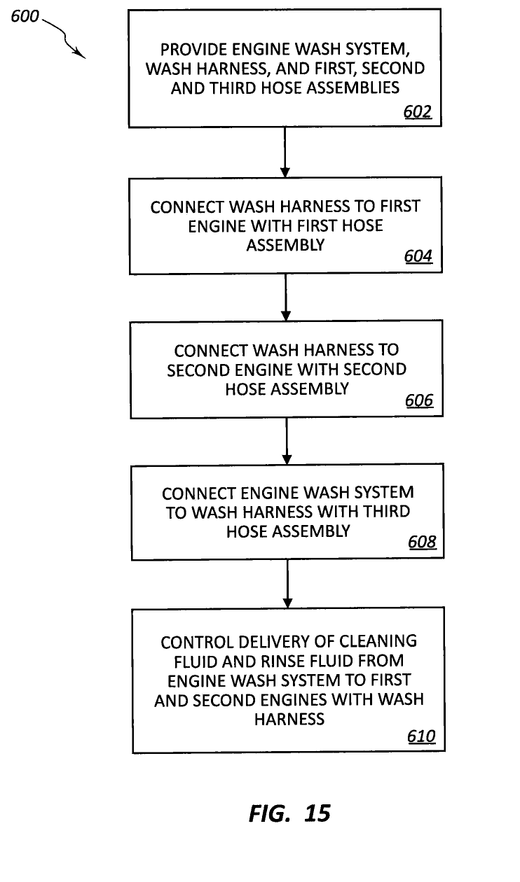

Referring to FIG. 15, a method 600 includes providing an engine wash system, a wash harness, and first, second and third hose assemblies in step 602. Step 604 includes connecting the wash harness to a first engine with the first hose assembly. A step 606 includes connecting the wash harness to a second engine with the second hose assembly. Step 606 includes connecting the wash harness to a second engine with the second hose assembly. The engine wash system is connected to the wash harness with the third hose assembly in step 608. Delivery of cleaning fluid and rinse fluid from the engine wash system to the first and second engines is controlled with the wash harness in step 610.

Other steps of method 600 may include, for example, spooling up the first and second engines prior to delivering the cleaning and rinse fluids. The method 600 may include delivering the cleaning or rinse fluids in sequence to the first and second engines. The method 600 may include delivering one of the cleaning fluid and rinse fluid to the second engine during a dwell period for the cleaning fluid or rinse fluid in the first engine.

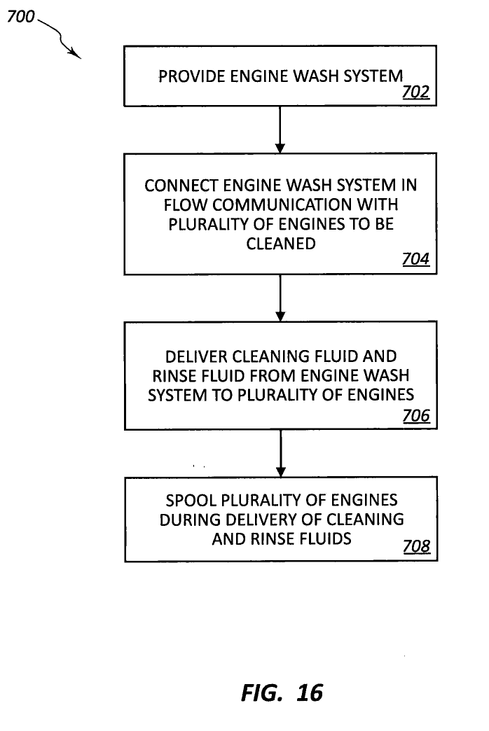

FIG. 16 shows a method 700 that includes a first step 702 of providing an engine wash system. The engine wash system is connected in full communication with a plurality of engines to be cleaned in a step 704. Cleaning fluid and rinse fluid from the engine wash system are delivered to the plurality of engines in a step 706. Step 708 includes spooling the plurality of engines during delivery of the cleaning and rinse fluids.

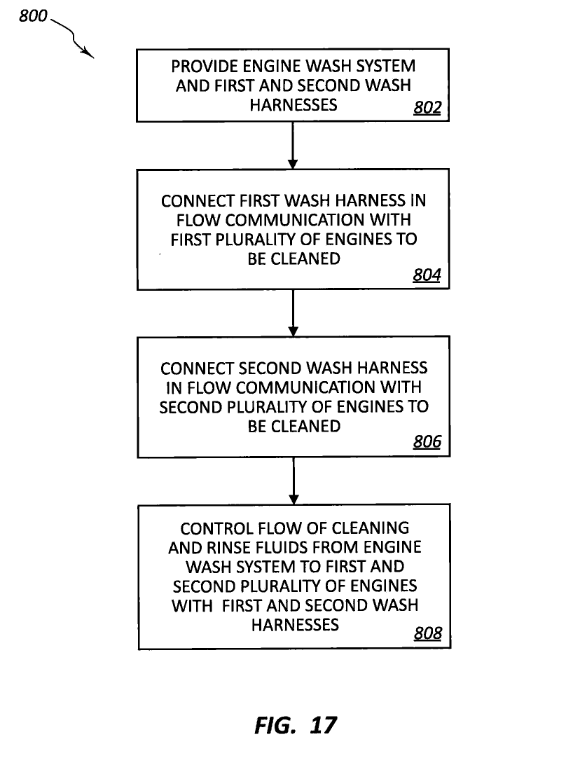

Referring to FIG. 17, a method 800 includes a first step of providing an engine wash system and first and second wash harnesses in a step 802. A step 804 includes connecting a first wash harness in flow communication with the first plurality of engines to be cleaned. A step 806 includes connecting the second wash harness in flow communication with the second plurality of engines to be cleaned. A step 808 includes controlling the flow of cleaning and rinse fluids from the engine wash system to the first and second plurality of engines using the first and second wash harnesses.

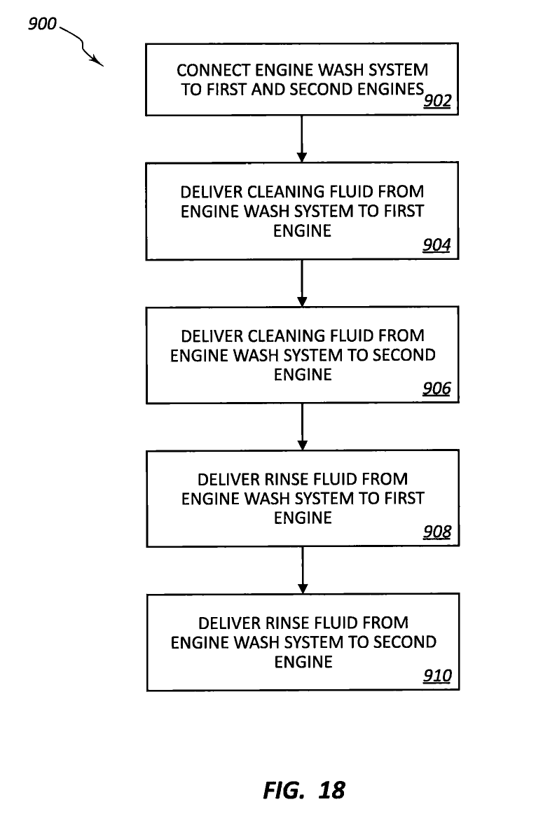

FIG. 18 shows a method 900 that includes a first step 902 of connecting an engine wash system to first and second engines. A step 904 includes delivering cleaning fluid from the engine wash system to the first engine, followed by delivering cleaning fluid from the engine wash system to the second engine in a step 906. A following step 908 includes delivering rinse fluid from the engine wash system to the first engine. A following step 910 includes delivering rinse fluid from the engine wash system to the second engine.

Other steps may be included in method 900 including, for example, spooling up the first engine prior to step 904 and spooling down the first engine prior to step 906, and spooling up the second engine prior to step 906 and spooling down the second engine before step 908. Other steps of method 900 may include spooling up the first engine before step 908 and spooling down the first engine before step 910, and spooling up the second engine before step 910 and spooling down the second engine after step 910. The method 900 may include connecting a wash harness in flow communication between the engine wash system and the first and second engines. The method 900 may include controlling delivery of the cleaning and rinse fluids to the first and second engines with the wash harness.

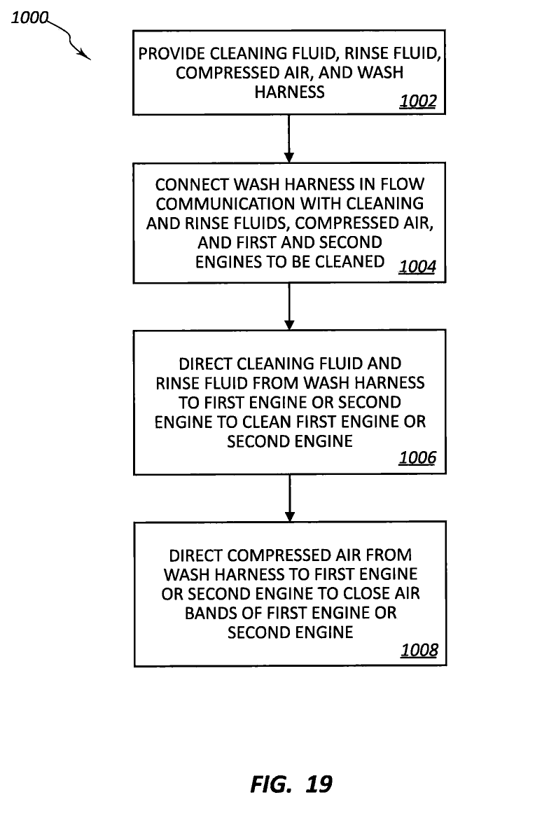

FIG. 19 shows a method 1000 including a first step 1002 of providing cleaning fluid, rinse fluid, compressed air, and a wash harness. A step 1004 includes connecting the wash harness in flow communication with the cleaning and rinse fluids, compressed air, and first and second engines to be cleaned. The cleaning fluid and rinse fluid are directed from the wash harness to the first engine or second engine to clean the first engine or second engine in a step 1006. A step 1008 includes directing compressed air from the wash harness to the first engine or second engine to close air bands of the first engine or second engine.

Other steps of method 1000 may include, for example, providing the cleaning fluid, rinse fluid and compressed air to the wash harness using an engine wash system. The compressed air may be directed to the first or second engine prior to directing cleaning fluid and rinse fluid to the first or second engine. Method 1000 may also include spooling up and spooling down the first and second engines prior to and after directing the cleaning fluid and rinse fluids to the first or second engine.

Any of the methods and steps shown and described with reference to FIGS. 14-19 may be added to or taken away from the methods of FIGS. 14-19 or the other methods disclosed herein. Further, while the methods shown in FIGS. 14-19 are directed to cleaning two engines in most cases, the methods may be altered to include cleaning of more than two engines. For example, the method 900 of FIG. 18 may include connecting the engine wash system to three or more engines, delivering cleaning fluid to each of the three or more engines, and delivering rinse fluid to each of the three or more engines. Connecting the engine wash system to multiple engines facilitates having cleaning fluid and rinse fluid in the multiple engines at the same time, and permits sequential delivery of cleaning and rinse fluids to the multiple engines without having to connect and disconnect to the engine wash system to the multiple engines to complete the cleaning process. The methods of FIGS. 14-19 may also include delivery of compressed air from the engine wash system to the engines.

The preceding description has been presented only to illustrate and describe exemplary embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A turbine engine cleaning system, comprising:
a source of cleaning fluid;
a source of rinse fluid;
a pump configured to deliver the cleaning fluid and rinse fluid under pressure;
a wash harness connected in flow communication with a plurality of turbine engines, the wash harness being configured to direct cleaning fluid from the source of cleaning fluid and rinse fluid from the source of rinse fluid to the plurality of turbine engines in sequence.

2. The turbine engine cleaning system of claim 1, wherein the wash harness includes a valve system, the valve system being operable to control flow of the cleaning fluid and rinse fluid from the wash harness to the plurality of turbine engines.

3. The turbine engine cleaning system of claim 1, further comprising a first hose assembly connecting the wash harness to a first of the plurality of turbine engines, a second hose assembly connecting the wash harness to a second of the plurality of turbine engines, and a third hose assembly connecting the wash harness in flow communication with the pump.

4. The turbine engine cleaning system of claim 3, wherein each of the first, second and third hose assemblies include at least one hose.

5. The turbine engine cleaning system of claim 1, wherein the pump, source of cleaning fluid and source of rinse fluid are carried on a mobile cart, and the wash harness is portable relative to the mobile cart.

6. The turbine engine cleaning system of claim 1, further comprising a compressor configured to provide compressed air to the plurality of turbine engines via the wash harness.

7. The turbine engine cleaning system of claim 1, wherein the cleaning fluid and rinse fluid are directed from the wash harness to only one of the plurality of turbine engines at a time.

8. The turbine engine cleaning system of claim 1, wherein one of the cleaning fluid and the rinse fluid dwell in one of the plurality of turbine engines while one of the cleaning fluid and the rinse fluid is directed to the other of the plurality of turbine engines.

9. The turbine engine cleaning system of claim 1, wherein the cleaning fluid comprises a detergent.

10. The turbine engine cleaning system of claim 1, wherein the wash harness is connected in flow communication with at least one of a compressor portion and a combustion portion of each of the plurality of turbine engines.

11. A turbine engine cleaning system, comprising:
a first hose assembly connected in flow communication a first turbine engine;
a second hose assembly connected in flow communication with a second turbine engine;
a pump system;
a wash harness connected in flow communication with the first and second hose assemblies and the pump system, the wash harness being operable to control flow of cleaning fluid and rinse fluid from the pump system to the first and second hose assemblies to clean the first and second turbine engines simultaneously.

12. The turbine engine cleaning system of claim 11, further comprising a first tank holding the cleaning fluid, a second tank holding the rinse fluid, and a mobile cart, the mobile cart configured to carry the pump system and the first and second tanks.

13. The turbine engine cleaning system of claim 11, wherein the first and second hose assemblies each include a liquid hose connected to a cleaning inlet of the first and second turbine engines, and an air hose connected to an air inlet of the first and second turbine engines.

14. The turbine engine cleaning system of claim 11, wherein the wash harness is portable relative to the pump system.

15. The turbine engine cleaning system of claim 11, wherein the pump system includes a plurality of valves configured to control the flow of cleaning fluid and rinse fluid to and from the wash harness.

16. The turbine engine cleaning system of claim 11, wherein the first hose assembly is connected in flow communication with at least one of a compressor portion and a combustion portion of the first turbine engine, and the second hose assembly is connected in flow communication with at least one of a compressor portion and a combustion portion of the second turbine engine.

17. A method of concurrently cleaning a plurality of turbine engines, comprising:
providing a cleaning fluid, a rinse fluid, a pump, and a wash harness;
connecting the wash harness in flow communication with the pump and the plurality of turbine engines;
delivering the cleaning fluid and rinse fluid under pressure to the wash harness with the pump;
directing the cleaning fluid and rinse fluid to a first of the plurality of turbine engines and a second of the plurality of turbine engines with the wash harness to clean the first and second turbine engines.

18. The method of claim 17, further comprising spooling the first turbine engine before directing the cleaning fluid and rinse fluid to the first turbine engine, and spooling the second turbine engine before directing the cleaning fluid and rinse fluid to the second turbine engine.

19. The method of claim 17, wherein directing the cleaning fluid and the rinse fluid includes delivering the cleaning fluid first followed by delivering the rinse fluid.

20. The method of claim 17, wherein directing the cleaning fluid and the rinse fluid includes delivering the cleaning fluid to the first turbine engine, followed by delivering cleaning fluid to the second turbine engine, followed by delivering rinse fluid to the first turbine engine, followed by delivering rinse fluid to the second turbine engine.

21. The method of claim 17, wherein connecting the wash harness in flow communication with the plurality of turbine engines includes connecting to at least one of an engine compressor and a combustion portion of each of the first and second turbine engines.

22. The method of claim 17, further comprising permitting a dwell time to elapse between directing the cleaning fluid to the first and second turbine engines and directing the rinse fluid to the first and second turbine engines.
